(19) United States
(12) Patent Application Publication
(10) Pub. No.: US 2023/0014298 A1
(43) Pub. Date: Jan. 19, 2023

(54) TRACK ASSEMBLY FOR POWER MACHINE

(71) Applicant: Clark Equipment Company, West Fargo, ND (US)

(72) Inventors: Dennis Agnew, Moffit, ND (US); Matthew Sagaser, Bismarck, ND (US)

(21) Appl. No.: 17/867,197

(22) Filed: Jul. 18, 2022

Related U.S. Application Data
(60) Provisional application No. 63/222,634, filed on Jul. 16, 2021.

(51) Int. Cl. E02F 3/34; B62D 55/10

(52) U.S. Cl. CPC E02F 3/3414; B62D 55/10; B62D 55/065

(57) ABSTRACT

A power machine configured as a mini-loader includes a mini-loader frame defining a front end opposite a rear end and a first side opposite a second side, at least one first-side motor supported by the first side of the frame, at least one second-side motor supported by the second side of the frame, and four endless track pods. The four endless track pods include a first endless track pod and a second endless track pod supported by the first side of the frame, and a third endless track pod and a fourth endless track pod supported by the second side of the frame. The endless tracks of the first and second endless track pods are powered by the at least one first-side motor and the endless tracks of the third and fourth endless track pods are powered by the at least one second-side motor to propel the power machine.

### CROSS-REFERENCE TO RELATED APPLICATIONS

This application claims priority to U.S. provisional patent application No. 63/222,634, filed Jul. 16, 2021, the entirety of which is incorporated herein by reference.

### BACKGROUND

This disclosure is directed toward power machines. More particularly, this disclosure relates to tractive elements of power machines, including for power machine configurations having a plurality of tractive elements (e.g., track pods). Power machines, for the purposes of this disclosure, include any type of machine that generates power to accomplish a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include loaders (including mini-loaders), excavators, utility vehicles, tractors, mowers, and trenchers, to name a few examples.

Power machines can include a variety of tractive elements to propel the power machine across a variety of terrain or other support surfaces. For example, some power machines include a dual-track drive (or tractive) assembly having a single ground engaging endless track on each lateral side of the power machine, while other power machines may include wheeled drive assemblies with ground-engaging wheels. Still, other power machines include a quad-track drive assembly having four ground-engaging endless track pods. The relative utility of the various drive assemblies may vary depending on the type of terrain or support surface, and depending on the type of power machine, the operator, other aspects of the configuration of the relevant power machine, the operations to be executed, and various other factors.

The discussion above is merely provided for general background information and is not intended to be used as an aid in determining the scope of the claimed subject matter.

### SUMMARY

Embodiments of the disclosed subject matter can allow power machines, including mini-loaders, to be equipped with four endless track pods. The endless track pods may be factory-installed on a power machine (e.g., mini-loader) or they may be provided as retrofit kit to convert a wheeled or dual-track mini-loader into a quad-track mini-loader.

In some examples, a power machine configured as a mini-loader may include a mini-loader frame defining a front end opposite a rear end and a first side opposite a second side, at least one first-side motor supported by the first side of the mini-loader frame, at least one second-side motor supported by the second side of the mini-loader frame, and four endless track pods. The four endless track pods may include a first endless track pod that may be supported by the first side of the mini-loader frame, a second endless track pod that may be supported by the first side of the mini-loader frame, a third endless track pod that may be supported by the second side of the mini-loader frame, and a fourth endless track pod that may be supported by the second side of the mini-loader frame. The endless tracks of the first and second endless track pods may be powered by the at least one first-side motor and the endless tracks of the third and fourth endless track pods may be powered by the at least one second-side motor to propel the power machine.

In some examples, a pin may be secured to one of the mini-loader frame or the first endless track pod, and a U-shaped bracket may be secured to the other of the mini-loader frame or the first endless track pod. The pin may engage the U-shaped bracket to limit rotation of the first endless track pod relative to the mini-loader frame.

In some examples, the power machine may further include at least one first drive chain that may operatively connect the at least one first-side motor with the first and second endless track pods and at least one second drive chain that may operatively connect the at least one second-side motor with the third and fourth endless track pods.

In some examples, the at least one first drive chain may include a first continuous drive chain that extends from the at least one first-side motor to each of the first and second endless track pods. The at least one second drive chain may include a second continuous drive chain that extends from the at least one second-side motor to each of the third and fourth endless track pods.

In some examples, the at least one first drive chain may include a first continuous drive chain that may extend from the at least one first-side motor to the first endless track pod and a second continuous drive chain. The second continuous drive chain may extend from the first at least one motor to the second endless track pod, or from the first endless track pod to the second endless track pod. The at least one second drive chain may include a third continuous drive chain that may extend from the second at least one motor to the third endless track pod and a fourth continuous drive chain. The fourth continuous drive chain may extend from the at least one second-side motor to the fourth endless track pod, or from the third endless track pod to the fourth endless track pod.

In other examples, the first and third endless track pods may be supported adjacent to the front end of the mini-loader frame, and the second and fourth endless track pods may be supported adjacent to the rear end of the mini-loader frame. The at least one first-side motor may be secured to the first side of the mini-loader frame and may be disposed above and between the first endless track pod and the second endless track pod. The at least one second-side motor may be secured to the second side of the mini-loader frame and may be disposed above and between the third endless track pod and the fourth endless track pod.

In other examples, the at least one first drive chain may operatively connect the at least one first-side motor to the first and second endless track pods and may form a first triangular chain path. The at least one second drive chain may operatively connect the at least one second-side motor to the third and fourth endless track pods and may form a second triangular chain path.

In some examples, each of the at least one first-side motor and the at least one second-side motor may substantially extend to the inside of the first and second sides of the mini-loader frame, respectively.

In some examples one or more of the at least one first-side motor may be configured to power at least one of the first or second endless track pods directly, and one or more of the at least one second-side motor may be configured to power at least one of the third or fourth endless track pods directly.

In some examples, a first drive motor of the at least one first-side motor may be configured to directly power the first endless track pod. A second drive motor of the at least one first-side motor may be configured to directly power with the second endless track pod. A third drive motor of the at least one second-side motor may be configured to directly power the third endless track pod. A fourth drive motor of the at least one second-side motor may be configured to directly power the fourth endless track pod.

In some examples, each of the at least one first-side motor and the second-side motor may substantially extend inboard of the first and second sides of the mini-loader frame, respectively. In other examples, each of the at least one first-side motor and the at least one second-side motor may substantially extend outboard of the first and second sides of the mini-loader frame, respectively.

In other examples, drive assembly for a power machine having a frame defining a first side, and a front end opposite a rear end may include a drive motor configured to be supported by the frame, a first endless track pod configured to be positioned adjacent the rear end of the frame, a second endless track pod configured to be positioned adjacent the front end of the frame, a drive chain configured to operatively connect with at least one of the first and the second track pods, and a chain enclosure configured to enclose the drive chain. The motor may be configured to be secured to the first side of the frame of the power machine, and to be positioned above and between the first endless track pod and the second endless track pod

In some examples, the drive chain may be configured to operatively connect the motor to the first and second endless track pods and may form a triangular chain path.

In some examples, the drive chain may be a first drive chain that may be configured to operatively connect the drive motor to one of the first or second endless track pods. Additionally, a second drive chain may be configured to operatively connect the one of the first or second endless track pods to the other of the first or second endless track pods, or to operatively connect the drive motor to the other of the first or second endless track pods.

In some examples, the drive motor may be configured to substantially extend inboard of the frame when secured to the first side of the frame.

In some examples the drive assembly may further include a chain enclosure that may be configured to couple with the frame of the power machine, and to couple with the first and second endless track pods. The chain enclosure may support the first and second endless track pods relative to the frame, and the chain enclosure may be disposed between the first side of the frame and the first and second endless track pods.

In other examples, a retrofit kit may be provided for a power machine configured as a mini-loader having a mini-loader frame that supports a power source and a work element and that defines a front end opposite a rear end, and a first side opposite a second side. The retrofit kit may include at least one motor, a first endless track pod, a second endless track pod, and a drive chain assembly. The first endless track pod may be configured to be mounted to the mini-loader frame with the first endless track pod adjacent the front end of the mini-loader frame on the first side of the mini-loader frame. The second endless track pod may be configured to be mounted to the mini-loader frame with the second endless track pod adjacent the rear end of the mini-loader frame on the first side of the mini-loader frame. The drive chain assembly may operatively connect the at least one motor with the first endless track pod and the second endless track pod to provide tractive power at the first and second endless track pods.

In some examples, a drive assembly retrofit kit may further include at least one chain enclosure that may be configured to enclose one or more drive chains of the drive chain assembly. In some cases, the chain enclosure can secure the first and second endless track pods to the mini-loader frame. In some cases, at least one motor may be configured to be mounted directly to a mini-loader frame, separately from a chain enclosure (if any). For example, at least one motor may be directly mounted to a frame of a mini-loader and may extend substantially inboard relative to the frame (e.g., through a circular hole in the mini-loader frame).

In some examples, at least one motor may be configured to be mounted to the mini-loader frame by a corresponding chain enclosure. For example, a prefabricated retrofit kit may include a unitary assembly with a chain enclosure independently supporting a set of track pods and one or more motors. The chain enclosure can then be mountable to a mini-loader frame (e.g., using pre-existing mounting brackets or holes) to operatively secure the entire drive assembly to the frame.

In some examples, the drive assembly retrofit kit may further include a third endless track pod, a fourth endless track pod, and a base frame. The third endless track pod may be configured to be mounted to the mini-loader frame with the third endless track pod adjacent the front end of the mini-loader frame on the second side of the mini-loader frame. The fourth endless track pod may be configured to be mounted to the mini-loader frame with the fourth endless track pod adjacent the front end of the mini-loader frame on the second side of the mini-loader frame. The base frame may support each of the first, second, third, and fourth endless track pods and may be configured to be mounted below the mini-loader frame to operatively couple the first, second, third, and fourth endless track pods to the mini-loader frame.

In some examples a method is disclosed for converting a power machine, configured as a mini-loader with a mini-loader frame, from a wheeled or dual-track configuration to a quad-track configuration. The method may include the operations of removing an existing drive assembly from the mini-loader frame, securing at least one motor to the mini-loader frame, securing a first endless track pod and a second endless track pod to a first side of the mini-loader frame, and operatively coupling the at least one motor to the first and second endless track pods to provide tractive power to the first and second endless track pods.

In some examples, the method may further include the operation of securing a chain enclosure to the first side of the mini-loader frame. The chain enclosure may be configured to support the first and second endless track pods relative to the mini-loader frame. The at least one motor may be secured to the mini-loader frame by the chain enclosure. Alternatively, the at least one motor may be secured to the mini-loader frame separately from the chain enclosure.

In some examples, a method can be provided of converting a power machine from a dual-track configuration to a quad-track configuration, the power machine being configured as a mini-loader with a mini-loader frame. An installed dual-track track and dual-track track frame can be removed from a first side of the power machine. An installed dual-track drive sprocket of the dual-track configuration can be removed from the first side of the power machine, the dual-track drive sprocket being configured to drive the installed dual-track track with the power machine in the dual-track configuration. A chain sprocket can be secured to the power machine in place of the dual-track drive sprocket. A first endless track pod and a second endless track pod can be rigidly secured to the first side of the mini-loader frame. The chain sprocket can be operatively coupled to the first and second endless track pods, with one or more chains, to provide tractive power to the first and second endless track pods.

In some examples, a first-side drive motor of the power machine can be secured to the power machine in a first orientation to provide tractive power to the dual-track track. The first-side drive motor can remain in the first orientation to provide tractive power to the first and second endless track pods via the chain sprocket and the chain.

This Summary and the Abstract are provided to introduce a selection of concepts in a simplified form that are further described below in the Detailed Description. This Summary is not intended to identify key features or essential features of the claimed subject matter, nor are they intended to be used as an aid in determining the scope of the claimed subject matter.

### DRAWINGS

FIG. 1 is a block diagram illustrating functional systems of a representative power machine on which embodiments of the present disclosure can be advantageously practiced.

FIGS. 2-3 illustrate perspective views of a representative power machine in the form of a skid-steer loader of the type on which the disclosed embodiments can be practiced.

FIG. 4 is a block diagram illustrating components of a power system of a loader such as the loader illustrated in FIGS. 2-3.

FIG. 5 illustrates a side perspective view of a representative power machine in the form of a quad-track mini-loader on which some of the disclosed technology can be practiced.

FIG. 6 illustrates a partial side perspective view of the power machine of FIG. 5.

FIGS. 7-9 illustrate schematic front elevation views of a side of the power machine of FIG. 5 showing example configurations for a motor of a drive assembly.

FIG. 10 illustrates a side perspective view of another representative power machine in the form of a quad-track mini-loader on which some of the disclosed technology can be practiced.

FIG. 11 illustrates a side perspective view of another representative power machine in the form of a quad-track mini-loader on which some of the disclosed technology can be practiced.

FIG. 12 illustrates a side perspective view of another representative power machine in the form of a quad-track mini-loader on which the disclosed technology can be practiced.

FIG. 13 illustrates a side perspective view of another representative power machine in the form of a quad-track mini-loader on which some of the disclosed technology can be practiced.

FIG. 14 illustrates a side perspective view of another representative power machine in the form of a quad-track mini-loader on which some of the disclosed technology can be practiced.

FIG. 15 illustrates a side perspective view of a representative retrofit kit for a power machine in the form of a quad-track mini-loader on which some of the disclosed technology can be practiced.

FIG. 16 illustrates an example method for installing a retrofit kit onto a power machine according to the disclosed technology.

### DETAILED DESCRIPTION

Before any embodiments of the disclosure are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings unless identified as such.

Also as used herein, unless otherwise expressly defined or limited, “substantially extend” (and the like) describe a component that extends by a substantial portion of a length, width (e.g., diameter), or height of the component, and in particular, relative to a reference frame, for 75% or more (e.g., 80%, 90%, 95%, 98%) of a length, width, or height of the component. For example, a motor described as substantially extending inboard of a frame of a power machine can be arranged so that at least 75% of the length (or width, or height) of the motor extends laterally to the inside of a laterally exterior reference plane for the frame. Similarly, a motor described as substantially extending outboard of a frame of a power machine can be arranged so that at least 75% of the length (or width, or height) of the motor extends laterally to the outside of a laterally exterior reference plane for the frame.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Certain operations of methods according to the disclosure, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular embodiments of the disclosure. Further, in some embodiments, certain operations can be executed in parallel.

Power machines can be fitted with a variety of drive assemblies configured to propel the power machine over different types of terrain or other support surfaces. For example, power machines can include wheeled drive assemblies, dual-tracked drive assemblies, and quad-tracked drive assemblies. In some scenarios, outfitting a power machine with a quad-tracked drive assembly, and in particular so outfitting a mini-loader, can provide numerous advantages, including but not limited to enhanced traction, especially over rough terrain, and greater maneuverability for operating in tight or confined spaces. Correspondingly, it may sometimes be advantageous to reconfigure an existing wheeled or dual-track loader to a quad-track configuration.

Some of the embodiments disclosed herein can address these and other needs by providing different types of quad-tracked drive assemblies for a loader, and in particular for a mini-loader. Such drive assemblies may be factory installed on a power machine or may be provided as a retrofit kit for converting a wheeled or dual-track power machine to a quad-track power machine. As further detailed below, some embodiments can provide improved configurations for drive assemblies that can allow for easier installation and manufacturing of quad-track mini-loaders, as well as more robust operation of these and other power machines. Likewise, some embodiments can provide improved systems and methods to convert existing wheeled and dual-track loaders to quad-track loaders.

As noted above and further discussed below, some embodiments may be particularly suitable for implementation on a mini-loader. As used herein, “mini-loader” refers to a power machine that is smaller than traditional compact construction equipment. A specific form of mini-loader includes an operator station that is located at or near a rear portion of the loader and that can be accessed from the rear of the loader. More specifically, mini-loaders often do not have cabs or operator compartments where an operator can sit while operating the loader. In some implementations, a mini-loader can include only drive axles that are forward of an operator station, can include a rigid main frame (e.g., with no vertical pivot joint to connect separate frame portions), or can include only rigidly (i.e., non-steerably) mounted drive axles so that steering can be accomplished via control of speed differential between opposite-side tractive elements rather than via control to change the orientation of tractive elements relative to a main frame of the power machine.

In some embodiments a drive assembly for a quad-tracked power machine may include a motor configured to be supported by a frame of a power machine, two endless track pods, and a drive chain. Two drive assemblies may be used, one on each side of the frame, to provide the quad-tracked power machine with a total of four track pods. The motor may be a hydraulic (or other) motor that may be mounted internally or externally to the frame. When mounted internally the motor may extend through a hole in the frame such that, for example, a motor body may substantially extend internally of the frame, although a motor sprocket may be positioned externally of the frame. In some cases, a first track pod may be supported by the frame, proximate a rear end of the power machine and a second track pod may be supported by the frame proximate a front end of the power machine.

In some cases, each of the track pods may include a track frame, a track sprocket and rollers supported by the track frame, and an endless track surrounding and supported by the track frame, the track sprocket, and the rollers. The drive sprocket may be coupled the drive sprocket via a shaft so that the drive sprocket and track sprocket rotate together.

In some embodiments, the motor may be mounted above and between two or more track pods on a particular lateral side (i.e., left or right side) of a power machine. For example, in particular, the motor may be mounted above and between drive axles of two or more track pods on a particular lateral side of a power machine. In some embodiments, a drive chain may engage with a motor sprocket and a drive sprocket of each of multiple track pods, to form a triangular chain path that operatively connects the motor to the track pods to propel the power machine. In some embodiments, the motor may be directly coupled with one of the track pods, and the drive chain may operatively connect the two track pods together, as may potentially provide a more compact drive assembly. In some embodiments, a respective motor may separately drive each of multiple track pods (e.g., with four drive motors in total to power four track pods)

In some embodiments, track pods may be directly supported by the frame of the power machine. For example, track pods may be rotatably coupled with the frame so that each of the track pods may rotate relative to the frame and independently of one another (e.g., each with a limited range of rotational motion).

Generally, anti-rotation features may be included on track pods and a frame to limit the extent of the rotation of each of the pods. In some cases, each track pod may include an anti-rotation feature, such as, for example, a bracket or a pin, and a drive sprocket. For example, each track pod may include a bracket configured to receive a pin extending from the frame, or vice versa. The bracket may have a u-shape defining two walls that acts as limit stops, which prevent the track pod from rotating when the pin contacts one of the two walls.

In some embodiments, a drive assembly may include one or more chain enclosures configured to enclose the drive chain partially or completely. For example, a chain enclosure may include a front panel and a sidewall extending from the front panel to define an internal cavity. Generally, a chain enclosure may be configured as any shape as long as it may enclose the drive chain and may also be comprised of multiple sub enclosures; however, triangular shapes can be particularly beneficial in some cases for economy of materials and improved packaging for a power machine, including mini-loaders.

In some configurations, a chain enclosure may be configured to be fixedly coupled with the frame of a power machine so that an internal cavity of the chain enclosure faces the frame and a front panel of the chain enclosure faces laterally outward relative to the power machine. Further, the front panel may be configured to be rotatably coupled to each of the track pods so that the chain enclosure is positioned between the track pods and the frame of the power machine, but the tracks of the track pods are laterally to the outside of the chain enclosure. For example, the chain enclosure may include a hole that receives a shaft of a track pod so that a drive sprocket of the track pod is positioned within the internal cavity. In some cases, a chain enclosure may include an anti-rotation feature, e.g., a pin or a bracket, on either the sidewall or the front face, which may be configured to engage with a corresponding bracket or pin of an attached track pod to limit the extent of rotation of the track pod.

In some embodiments, a chain enclosure may be configured to couple with a motor, including so that the chain enclosure supports the motor relative to a frame of a power machine. For example, a motor may be mounted within an interior cavity of the chain enclosure, or a motor may be mounted on the exterior of the chain enclosure. In some implementations, including those in which a chain enclosure is provided as part of a retrofit kit, mounting the motor externally to the frame may be advantageous, including to allow for relatively simple and quick installation.

In different embodiments, different numbers of motors or drive chains may be used. For example, in some configurations a single motor and two drive chains may be used. The motor may be positioned above and between the two track pods (e.g., above and between drive axles of the track pods), or it may be placed in line with and between the two track pods (e.g., within a height range defined by the track pods, and between drive axles of the track pods). In such an arrangement, a first of the two drive chains may operatively connect the motor (e.g., at a first motor sprocket) and the first track pod and a second of the two drive chains may operatively connect the motor (e.g., at a second motor sprocket) and the second drive pods. In some embodiments, a first drive chain may operatively connect between a motor and a first track pod, and a second chain may operatively connect the first track pod to a second track pod, so that power is transferred from the motor to the second track pod via the first track pod.

In other embodiments, two motors and two chains may be used for a particular lateral side of a power machine. For example, each of two motors may be operatively connected with a respective track pod so that each motor drives just one track pod (e.g., with four motors driving four track pods for the power machine as a whole). Connecting a single motor to a single track pod can be advantageous, for example, because it allows each of the respective track pods to be individually controlled, which may facilitate improved traction and maneuverability. Further, chain-driven arrangements can be advantageous to packaging and structural efficiency in some cases, including because the relevant motors can be placed at a variety of locations along the side of a frame of a power machine, with the length and orientation of the relevant drive chains then varied accordingly.

In some embodiments, a track pod can be configured to be directly driven by a motor. For example, one or more motors may be separately directly connected with one or more respective track pods, so that each of the track pods are directly driven by a respective one of the motors (i.e., with no drive chains required). In some cases, use of direct drive configurations can allow for simpler installation of retrofit kits. Further, because no drive chain may be required in these configurations, a chain enclosure may also not be required.

In some embodiments, as also generally noted above, a drive assembly may be configured as a retrofit kit configured to convert a wheeled or dual-tracked power machine to a quad-track power machine. In some cases, a drive assembly retrofit kit may include at least one motor and at least two track pods configured to be powered by the motor(s) (e.g., with two motors and four track pods in total for a mini-loader). As applicable, the drive assembly may also include one or more drive chains and one or more chain enclosures. To convert a wheeled or dual-track power machine to a quad-track power machine, an existing drive assembly can be first removed from the power machine. This may include, for example, detaching hydraulic connections, removing one or more drive motors, wheels, or track assemblies, along with related fasteners, bushings, bearings, etc. Once the existing drive assembly has been removed, the retrofit kit may be installed. For example, any of the variety of drive assemblies discussed above (or below) can be secured to the power machine frame, relevant hydraulic connections provided, chains tensioned as needed, and appropriate fasteners, etc. installed. Some components, such as a drive motor may be removed and reinstalled in a new position. Therefore the retrofit kit may potentially provide new mounting hardware, but the original component may be reused.

In some cases, a retrofit kit may be provided as multiple separate components that are each installed onto the loader. For example, a motor may be secured to the frame in an existing motor mount location, and any required hydraulic connection for the motor may be made. Then track pods and a chain enclosure may be installed. For example, the track pods can be secured to the chain enclosure and the combined track pods and chain enclosure may be secured to the frame and operatively coupled to the motor. Alternatively, a chain enclosure may be installed onto the frame before track pods, then the track pods may be mounted to the chain casing. In either case, the drive chain can be routed around the motor and the track pods to operatively connect the motor to the track pods for powered travel. In some cases, a retrofit kit can be installed using existing holes and other mounting features (e.g., brackets). In some cases, however, installation of a retrofit kit may require additional operations such as drilling new holes, attaching new brackets, and so on.

In other embodiments, a retrofit kit may be pre-assembled during manufacturing. For example, before delivery of a retrofit kit for installation, track pods and a motor may be mounted to a chain enclosure (e.g., in an outboard or inboard configuration) and one or more drive chains may be routed between the motor and the track pods. With a retrofit kit having been preassembled, the retrofit kit may then be mounted to a frame as a single drive assembly unit.

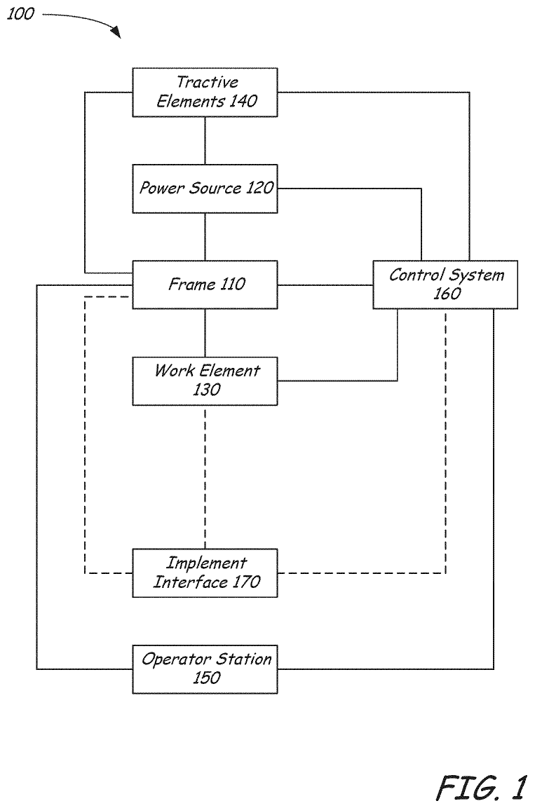

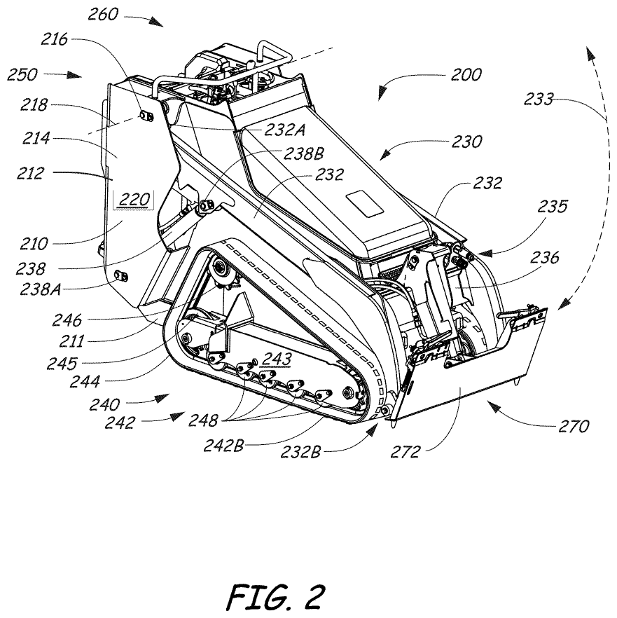

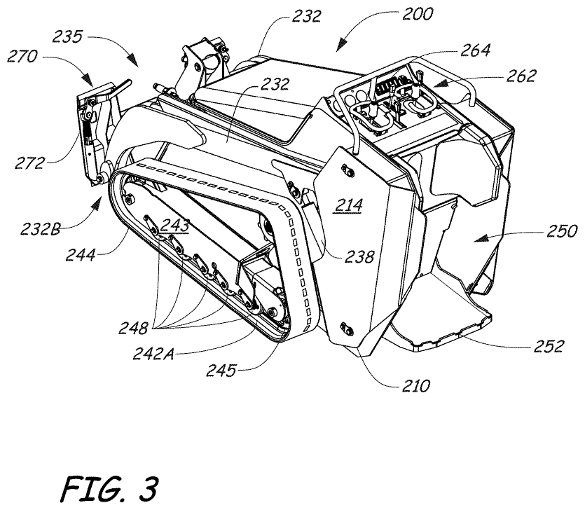

These concepts can be practiced on various power machines, as will be described below. A representative power machine on which the embodiments can be practiced is illustrated in diagram form in FIG. 1 and one example of such a power machine is illustrated in FIGS. 2-3 and described below before any embodiments are disclosed. For the sake of brevity, only one power machine is illustrated and discussed as being a representative power machine. However, as mentioned above, the embodiments below can be practiced on any of a number of power machines, including power machines of different types from the representative power machine shown in FIGS. 2-3. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power. Some embodiments disclosed herein can be practiced particularly advantageously on power machines configured as a mini-loader.

FIG. 1 is a block diagram that illustrates the basic systems of a power machine 100, which represents any of a number of different types of power machines upon which the embodiments discussed below can be advantageously incorporated. The block diagram of FIG. 1 identifies various systems on power machine 100 and the relationship between various components and systems. As mentioned above, at the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks at least in part in response to control signals provided by an operator.

Certain work vehicles have work elements that can perform a dedicated task. For example, some work vehicles have a lift arm to which an implement such as a bucket is attached such as by a pinning arrangement. The work element, i.e., the lift arm can be manipulated to position the implement to perform the task. The implement, in some instances can be positioned relative to the work element, such as by rotating a bucket relative to a lift arm, to further position the implement. Under normal operation of such a work vehicle, the bucket is intended to be attached and under use. Such work vehicles may be able to accept other implements by disassembling the implement/work element combination and reassembling another implement in place of the original bucket. Other work vehicles, however, are intended to be used with a wide variety of implements and have an implement interface such as implement interface 170 shown in FIG. 1. At its most basic, implement interface 170 is a connection mechanism between the frame 110 or a work element 130 and an implement, which can be as simple as a connection point for attaching an implement directly to the frame 110 or a work element 130 or more complex, as discussed below.

On some power machines, implement interface 170 can include an implement carrier, which is a physical structure movably attached to a work element. The implement carrier has engagement features and locking features to accept and secure any of a number of different implements to the work element. One characteristic of such an implement carrier is that once an implement is attached to it, it is fixed to the implement (i.e. not movable with respect to the implement) and when the implement carrier is moved with respect to the work element, the implement moves with the implement carrier. The term implement carrier as used herein is not merely a pivotal connection point, but rather a dedicated device specifically intended to accept and be secured to various different implements. The implement carrier itself is mountable to a work element 130 such as a lift arm or the frame 110. Implement interface 170 can also include one or more power sources for providing power to one or more work elements on an implement. Some power machines can have a plurality of work element with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that can move with respect to another portion of the frame. For example, excavators can have an upper frame portion that rotates with respect to a lower frame portion. Other work vehicles have articulated frames such that one portion of the frame pivots with respect to another portion for accomplishing steering functions.

Frame 110 supports the power source 120, which is configured to provide power to one or more work elements 130 including the one or more tractive elements 140, as well as, in some instances, providing power for use by an attached implement via implement interface 170. Power from the power source 120 can be provided directly to any of the work elements 130, tractive elements 140, and implement interfaces 170. Alternatively, power from the power source 120 can be provided to a control system 160, which in turn selectively provides power to the elements that capable of using it to perform a work function. Power sources for power machines typically include an engine such as an internal combustion engine and a power conversion system such as a mechanical transmission or a hydraulic system that is configured to convert the output from an engine into a form of power that is usable by a work element. Other types of power sources can be incorporated into power machines, including electrical sources or a combination of power sources, known generally as hybrid power sources.

FIG. 1 shows a single work element designated as work element 130, but various power machines can have any number of work elements. Work elements are typically attached to the frame of the power machine and movable with respect to the frame when performing a work task. In addition, tractive elements 140 are a special case of work element in that their work function is generally to move the power machine 100 over a support surface. Tractive elements 140 are shown separate from the work element 130 because many power machines have additional work elements besides tractive elements (e.g., lift arms, mower decks, implements, etc.), although that is not always the case. Power machines can have any number of tractive elements, some or all of which can receive power from the power source 120 to propel the power machine 100. Tractive elements can be, for example, track assemblies, wheels attached to an axle, and the like. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame.

Power machine 100 includes an operator station 150 that includes an operating position from which an operator can control operation of the power machine. In some power machines, the operator station 150 is defined by an enclosed or partially enclosed cab. Some power machines on which the disclosed embodiments may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 100 and others, whether they have operator compartments or operator positions or not, may be capable of being operated remotely (i.e. from a remotely located operator station) instead of or in addition to an operator station adjacent or on the power machine. This can include applications where at least some of the operator-controlled functions of the power machine can be operated from an operating position associated with an implement that is coupled to the power machine. Alternatively, with some power machines, a remote-control device can be provided (i.e. remote from both the power machine and any implement to which is it coupled) that can control at least some of the operator-controlled functions on the power machine.

FIGS. 2-3 illustrates a loader 200, which is one particular example of a power machine of the type illustrated in FIG. 1 where the embodiments discussed below can be advantageously employed. Loader 200 is a tracked loader and more particularly, a mini-loader. For the purposes of this discussion, a mini-loader is a small loader relative to other compact loaders such as traditional skid-steer loaders and compact track loaders. As discussed above, specific mini-loaders do not have an operator cab or compartment, but instead can be operated from an operator station located at or near the rear of the loader. Some mini-loaders have a platform on which an operator can ride on. Other mini-loaders can be operated by an operator who walks behind the loader. Still other mini-loaders have a platform that is moveable or removable to allow an operator to alternatively ride on the platform or walk behind the loader. The loader 200 is an example of a dual-track tracked loader; other mini-loaders can be wheeled as well.

Loader 200 is one particular example of the power machine 100 illustrated broadly in FIG. 1 and discussed above. To that end, features of loader 200 described below include reference numbers that are generally similar to those used in FIG. 1. For example, loader 200 is described below as having a frame 210, just as power machine 100 has a frame 110. Track loader 200 is described herein to provide a reference for understanding one environment on which the embodiments described below related to operator controls may be practiced. The loader 200 should not be considered limiting especially as to features that loader 200 may have described herein that are not essential to the disclosed embodiments. Such features may or may not be included in power machines other than loader 200 upon which the embodiments disclosed below may be advantageously practiced. Unless specifically noted otherwise, embodiments disclosed below can be practiced on a variety of power machines, with the loader 200 being only one of those power machines. For example, some or all of the concepts discussed below can be practiced on many other types of work vehicles such as various other loaders, excavators, trenchers, and dozers, to name but a few examples.

As mentioned above, loader 200 includes frame 210. Frame 210 supports a power system 220, the power system being configured to generate or otherwise provide power for operating various functions on the power machine. Frame 210 also supports a work element in the form of a lift arm structure 230 that is selectively powered by the power system 220 in response to signals from an operator control system 260 and can perform various work tasks. As loader 200 is a work vehicle, frame 210 also supports a traction system 240, which is also selectively powered by power system 220 in response to signals from operator control system 260. The traction system 240 is configured to propel the power machine over a support surface. The lift arm structure 230 in turn supports an implement carrier 272, which is configured to receive and secure various implements to the loader 200 for performing various work tasks. The loader 200 can be operated from an operator station 250 from which an operator can manipulate various control devices to cause the power machine to perform various functions, discussed in more detail below. Frame 210 also supports a work element in the form of a lift arm structure 230 that is powered by the power system 220 and can perform various work tasks.

Various power machines that can include and/or interact with the structures and/or functions of embodiments discussed below can have various frame components that support various work elements. The elements of frame 210 discussed herein are provided for illustrative purposes and are not necessarily the only type of frame that a power machine on which the embodiments discussed below can be practiced can be employed, unless otherwise specifically indicated. Frame 210 of loader 200 includes an undercarriage or lower portion 211 of the frame and a mainframe or upper portion 212 of the frame that is supported by the undercarriage. The mainframe 212 of loader 200 is attached to the undercarriage 211 such as with fasteners or by welding the undercarriage to the mainframe. Mainframe 212 includes a pair of upright portions 214 located on either side and toward the rear of the mainframe that support a lift arm structure 230 and to which the lift arm structure 230 is pivotally attached. The lift arm structure 230 is illustratively pinned to each of the upright portions 214. The combination of mounting features on the upright portions 214 and the lift arm structure 230 and mounting hardware (including pins used to pin the lift arm structure to the mainframe 212) are collectively referred to as joints 216 (one is located on each of the upright portions 214) for the purposes of this discussion. Joints 216 are aligned along an axis 218 so that the lift arm structure is capable of pivoting, as discussed below, with respect to the frame 210 about axis 218. Other power machines may not include upright portions on either side of the frame or may not have a lift arm structure that is mountable to upright portions on either side and toward the rear of the frame. For example, some power machines may have a single arm, mounted to a single side of the power machine or to a front or rear end of the power machine. Other machines can have a plurality of work elements, including a plurality of lift arms, each of which is mounted to the machine in its own configuration. Frame 210 also supports a pair of tractive elements 242 on either side of the loader 200, which on loader 200 are track assemblies.

The lift arm structure 230 shown in FIGS. 2-3 is one example of a lift arm structure that can be attached to a power machine such as loader 200 or other power machines on which embodiments of the present discussion can be practiced. The lift arm structure 230 has a pair of lift arms 232 that are disposed on opposing sides of the frame 210. A first end 232A of each of the lift arms 232 is pivotally coupled to the power machine at joints 216 and a second end 232B of each of the lift arms is positioned forward of the frame 210 when in a lowered position as shown in FIG. 2. The lift arm structure 230 is moveable (i.e. the lift arm structure can be raised and lowered) under control of the loader 200 with respect to the frame 210. That movement (i.e. the raising and lowering of the lift arm structure 230) is described by a radial travel path, shown generally by arrow 233. For the purposes of this discussion, the travel path 233 of the lift arm structure 230 is defined by the path of movement of the second end 232B of the lift arm structure.

The lift arms 232 are each coupled to a cross member 236 that provides increased structural stability to the lift arm structure 230. A pair of actuators 238, which on loader 200 are hydraulic cylinders configured to selectively receive pressurized fluid from power system 220, are pivotally coupled to both the frame 210 and the lift arms 234 at pivotable joints 238A and 238B, respectively, on either side of the loader 200. The actuators 238 are sometimes referred to individually and collectively as lift cylinders. Actuation (i.e., extension and retraction) of the actuators 238 cause the lift arm structure 230 to pivot about joints 216 and thereby be raised and lowered along a fixed path illustrated by arrow 233. The lift arm structure 230 shown in FIGS. 2-3 is representative of one type of lift arm structure that may be coupled to the power machine 200. Other lift arm structures, with different geometries, components, and arrangements can be pivotally coupled to the loader 200 or other power machines upon which the embodiments discussed herein can be practiced without departing from the scope of the present discussion. For example, other machines can have lift arm structures with lift arms that each has two portions (as opposed to the single piece lift arms 232) that are pivotally coupled to each other along with a control arm to create a four-bar linkage and a substantially vertical travel path or at least more vertical than the radial path of lift arm structure 230. Other lift arm structures can have an extendable or telescoping lift arm. Still other lift arm structures can have several (i.e. more than two) portions segments or portions. Some lift arms, most notably lift arms on excavators but also possible on loaders, may have portions that are controllable to pivot with respect to another segment instead of moving in concert (i.e. along a pre-determined path) as is the case in the lift arm structure 230 shown in FIGS. 2-3. Some power machines have lift arm structures with a single lift arm, such as is known in excavators or even some loaders and other power machines. Other power machines can have a plurality of lift arm structures, each being independent of the other(s).

An exemplary implement interface 270 is provided at a second end 234B of the arm 234. The implement interface 270 includes an implement carrier 272 that is configured to accept and secure a variety of different implements to the lift arm 230. Such implements have a machine interface that is configured to be engaged with the implement carrier 272. The implement carrier 272 is pivotally mounted to the second end 232B of each of the arms 232. An implement carrier actuator 237 is operably coupled the lift arm structure 230 and the implement carrier 272 and are operable to rotate the implement carrier with respect to the lift arm structure. Other examples of power machines can have a plurality of implement carrier actuators. Still other examples of power machines of the type that can advantageously employ the disclosed embodiments discussed herein may not have an implement carrier such as implement carrier 272, but instead may allow only for implements to be directly attached to its lift arm structure such as by pinning.

The implement interface 270 also includes an implement power source 235 available for connection to an implement on the lift arm structure 230. The implement power source 235 includes pressurized hydraulic fluid ports to which an implement can be coupled. The pressurized hydraulic fluid port selectively provides pressurized hydraulic fluid for powering one or more functions or actuators on an implement. The implement power source can, but need not, include an electrical power source for powering electrical actuators and/or an electronic controller on an implement. The electrical power source can also include electrical conduits that are in communication with a data bus on the loader 200 to allow communication between a controller on an implement and electronic devices on the loader 200. It should be noted that the specific implement power source on loader 200 does not include an electrical power source.

The lower frame 211 supports and has attached to it a pair of tractive elements, identified in FIGS. 2-3 as left track assembly 242A and right track assembly 242B (collectively tractive elements 242). Each of the tractive elements 242 has a track frame 243 that is coupled to the frame 210. The track frame 243 supports and is surrounded by an endless track 244, which rotates under power to propel the loader 200 over a support surface. Various elements are coupled to or otherwise supported by the track frame 243 for engaging and supporting the endless track 244 and cause it to rotate about the track frame. For example, a sprocket 246 is supported by the track frame 243 and engages the endless track 244 to cause the endless track to rotate about the track frame. An idler 245 is held against the track 244 by a tensioner (not shown) to maintain proper tension on the track. The track frame 243 also supports a plurality of rollers 248, which engage the track and, through the track, the support surface to support and distribute the weight of the loader 200.

An operator station 250 is positioned toward the rear of the frame 210. A platform 252 is provided for the operator to stand. While standing on the platform 252, and operator has access to a plurality of operator control inputs 262 that, when manipulated by the operator, can provide control signals to control work functions of the power machine 200, including, for example, the traction system 240 and the lift arm 230. Operator control inputs 262 can include joysticks with adjacent reference bars to allow an operator to rest their hand against as they operate the joysticks.

Display devices 264 are provided in the operator station to give indications of information relatable to the operation of the power machines in a form that can be sensed by an operator, such as, for example audible and/or visual indications. Audible indications can be made in the form of buzzers, bells, and the like or via verbal communication. Visual indications can be made in the form of graphs, lights, icons, gauges, alphanumeric characters, and the like. Displays can be designed to provide dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided.

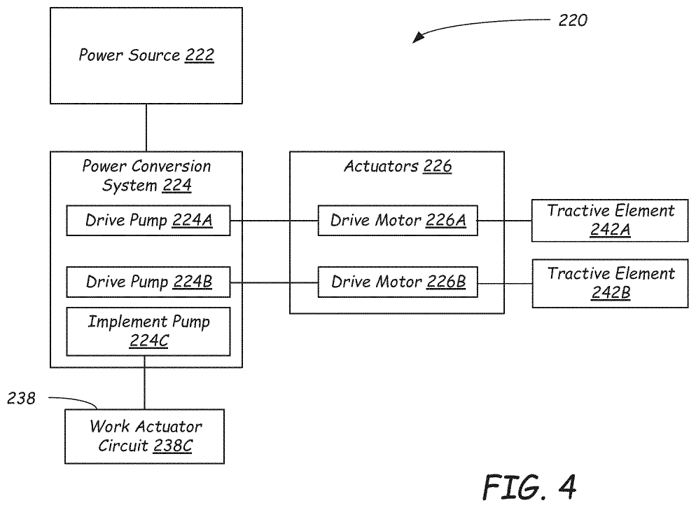

Frame 210 supports and generally encloses the power system 220 so that the various components of the power system 220 are not visible in FIGS. 2-3. FIG. 4 includes, among other things, a diagram of various components of the power system 220. Power system 220 includes one or more power sources 222 that are configured to generate and/or store power for use on various machine functions. On power machine 200, the power system 220 includes an internal combustion engine. Other power machines can include electric generators, rechargeable batteries, various other power sources or any combination of power sources that can provide power for given power machine components. The power system 220 also includes a power conversion system 224, which is operably coupled to the power source 222. Power conversion system 224 is, in turn, coupled to one or more actuators 226, which can perform a function on the power machine. Power conversion systems in various power machines can include various components, including mechanical transmissions, hydraulic systems, and the like. The power conversion system 224 of power machine 200 includes a pair of hydrostatic drive pumps 224A and 224B, which are selectively controllable to provide a power signal to drive motors 226A and 226B. The drive motors 226A and 226B in turn are each operably connected to tractive elements 242A, 242B, respectively. The drive pumps 224A and 224B can be mechanically, hydraulic, and/or electrically coupled to operator input devices to receive actuation signals for controlling the drive pumps.

The power conversion system 224 of power machine 200 also includes a hydraulic implement pump 224C, which is also operably coupled to the power source 222. The hydraulic implement pump 224C is operably coupled to work actuator circuit 238C. Work actuator circuit 238 includes lift cylinders 238 and tilt cylinders 235 as well as control logic to control actuation thereof. The control logic selectively allows, in response to operator inputs, for actuation of the lift cylinders and/or tilt cylinders. In some machines, the work actuator circuit also includes control logic to selectively provide a pressurized hydraulic fluid to an attached implement. The control logic of power machine 200 includes an open center, 3-spool valve in a series arrangement. The spools are arranged to give priority to the lift cylinders, then the tilt cylinders, and then pressurized fluid to an attached implement.

The description of power machine 100 and loader 200 above is provided for illustrative purposes, to provide illustrative environments on which the embodiments discussed below can be practiced. While the embodiments discussed can be practiced on a power machine such as is generally described by the power machine 100 shown in the block diagram of FIG. 1 and more particularly on a loader such as loader 200, unless otherwise noted or recited, the concepts discussed below are not intended to be limited in their application to the environments specifically described above.

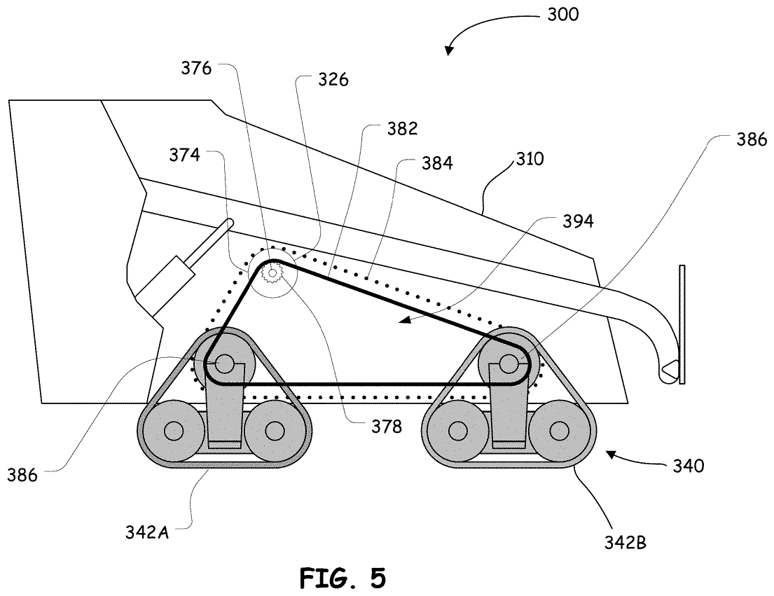

As also discussed above, it may be useful to equip power machines—and in particular mini-loaders—with quad-tracked drive systems. As detailed herein, different examples of such drive systems can be beneficially implemented in a variety of ways. For example, as illustrated in FIGS. 5-15 and further described below, the relative position of one or more motors, track pods or other tractive elements, flexible transmission elements, or chain enclosures can be varied to achieve numerous different drive configurations.

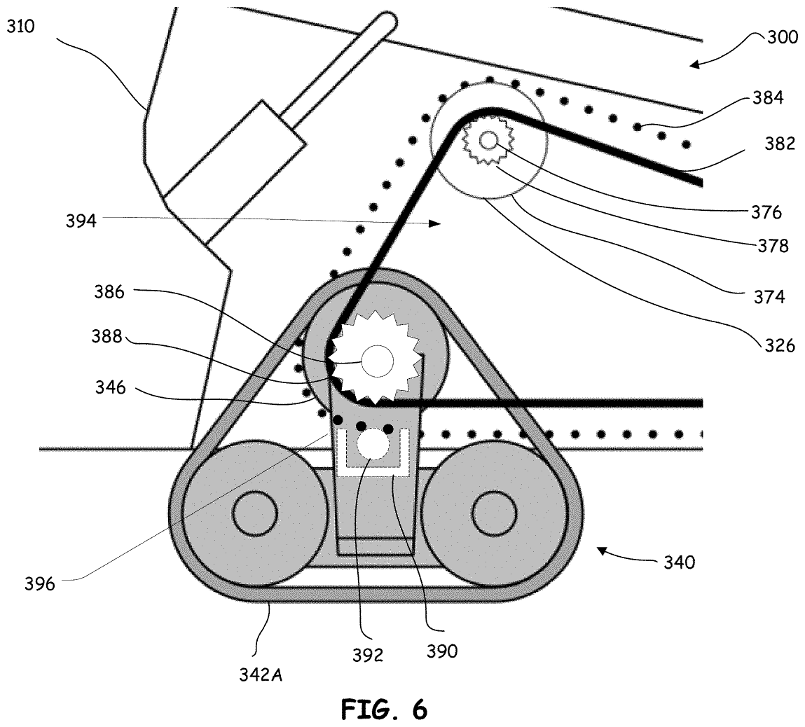

FIGS. 5 and 6 illustrate a loader 300, which is one particular example of a power machine of the type illustrated in FIG. 1, on which the embodiments discussed below can be advantageously employed. In particular, the loader 300 is a mini-loader, with a rearwardly mounted, forwardly extending lift arm. However, as similarly discussed regarding the loader 200, the particular configuration of the loader 300 as illustrated should not be considered limiting. Thus, although the illustrated embodiments may be particularly useful for mini-loaders, specific examples of the illustrated embodiments of the various figures, including as presented for any of FIGS. 5-15, can be practiced on a variety of power machines.

As best shown in FIG. 5, the quad-track mini-loader 300 includes a drive assembly in a high-drive configuration. As shown, the loader 300 may include a frame 310 defining a first side and a second side, each extending between a rear end that is opposite a front end. Each side of the loader 300 may include a drive motor 326 that may be supported by the frame 310 and a traction system 340. The drive motor 326 may include a motor housing 374, a shaft 376, and a motor drive sprocket 378 coupled with the shaft 376. The traction system 340 may include two distinct tractive elements configured as endless track pods 342A, 342B (collectively, tractive elements 342), a flexible power transmission element 382 configured as a drive chain that may operatively connect the drive motor 326 with each of the track pods 342A, 342B.

An example profile of a chain enclosure 384 is also illustrated, as may enclose the chain 382 within an interior cavity behind a face plate, although a wide variety of other configurations are possible. The chain enclosure 384 generally defines an interior cavity 394 shaped to enclose the path of the drive chain 382. In the illustrated example, the chain enclosure 384 has a triangular shape that entirely encloses the drive chain 382. However, other chain enclosures may have any number of shapes.

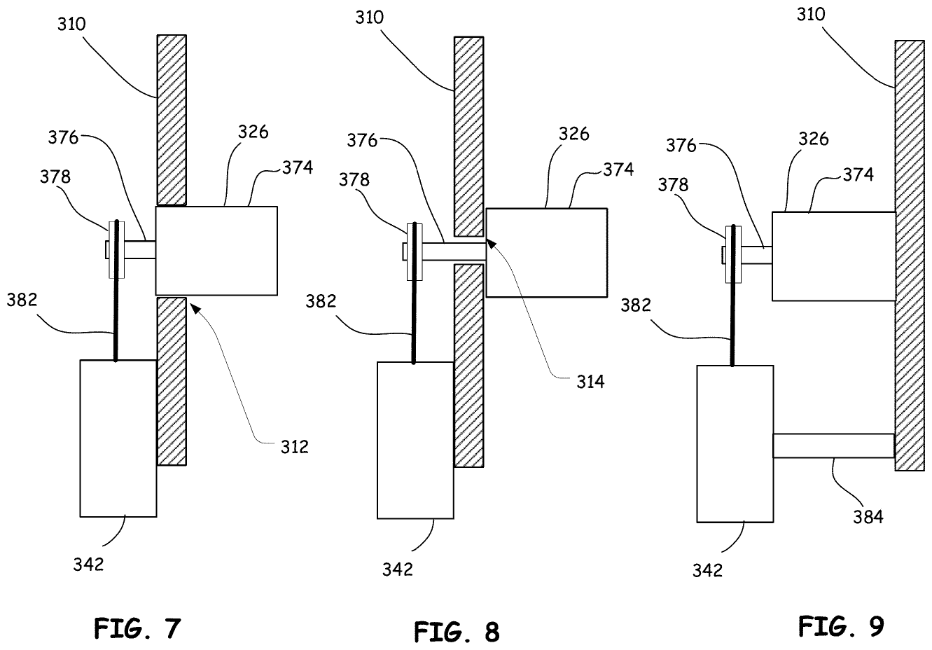

Although only a single side of the loader 300 is depicted, the opposing side of the loader 300 may be substantially similar in some cases, having similar components in a similar configuration. In particular, the opposing side of the loader 300 may include a second motor, a third track pod similar with the first track pod 342A, a fourth track pod corresponding with the second track pod, a second drive chain, and a second chain enclosure. Accordingly, the following discussion generally applies equally to the opposing side of the loader. Similar considerations also apply for other examples discussed below, including relative to FIGS. 7-15.

A variety of configurations for track pods can be used. As is best seen in FIG. 6, each of the track pods 342A, 342B, may include a drive shaft (or drive axle) 386 extending between and coupled with a drive sprocket 388 and a track sprocket 346, so that power from the motor 326 can be received and transmitted to the endless track of the track pod 342A. Additionally, the track pod 342A may include an anti-rotation bracket 390. In the illustrated example, the bracket 390 is a u-shaped bracket that is secured to a track pod frame 396 and is configured to move with the frame 396 to engage with a corresponding anti-rotation stop, configured here as a pin 392 that is secured to the frame 310 or, as available, the chain enclosure 384. In other embodiments, a U-shaped (or other) bracket can be secured to the frame 310 or to the chain enclosure 384, and a corresponding stop (e.g., pin) can be secured to the track frame 310.

In the illustrated configuration, the first endless track pod 342A may generally be supported by the frame 310 near the rear end of the frame 310 and the second endless track pod 342B may supported by the frame 310 near the front end of the frame 310. A variety of relative and absolute locations are possible, however, depending on the needs of a particular power machine, operation, operational profile, etc.

As is best seen in FIG. 5, in the illustrated high-drive configuration, the drive motor 326 may be mounted above and between the first and second track pods 342A, 342B and, in particular above the track pods and between drive axles 386 relative to a front-to-back direction. As shown, the drive motor 326 is located closer to the rear end of the loader 300 than the front end, as may help with overall weight balance and packaging. Further, the drive motor 326 is located fully above the track pods 342A, 342B and fully (locally) below a fully lowered position of a lift arm of the loader 300. However, in other embodiments the drive motor 326 may be otherwise located.

Turning to FIGS. 7-9, various mounting configurations of the drive motor 326 with respect to the frame 310 are shown. As with other example configurations discussed herein, although the motor configurations of FIGS. 7-9 are illustrated with respect to the power machine 300, similar principles can be applied relative to other power machines.

In some cases, the drive motor 326 may be advantageously mounted to extend substantially inboard of the frame 310, including as supported by a chain enclosure (not shown in FIG. 7) or any variety of known brackets (not shown). For example, referring to FIG. 7, the drive motor 326 may be secured to the frame 310 so that at least 60%, and preferably at least 82%, of the length of the drive motor housing 374 is disposed inboard of an adjacent outer surface of the frame 310. In some cases, however, the drive motor 326 may also be mounted substantially outboard of the frame 310, including so that less than 40% of the length of the drive motor 326 is disposed inboard of an adjacent outer surface of the frame 310.

Still referring to FIG. 7, the drive motor 326 substantially extends to the inside of the frame 310, with reference to the motor housing 374. In particular, the motor housing 374 extends through a hole 312 in the frame 310 so that the motor housing 374 is effectively flush with the exterior of the frame 310, but the shaft 376 and the drive motor sprocket 378 are disposed outside of the frame 310. In some cases, in which the traction system 340 is installed as a retrofit kit, the hole 312 may be a pre-existing hole for a previous drive configuration, and the motor housing 374 can be configured to be easily aligned for insertion into the hole 312 during installation.

As another example, with reference to FIG. 8, the drive motor 326 is shown mounted in a second substantially inboard configuration, in which the motor housing 374 of the drive motor 326 may be mounted entirely within the frame 310, and the shaft 376 extends through a smaller hole 314 in the frame 310 and the motor drive sprocket 378 may be disposed entirely outside of the frame 310. With reference to FIG. 9, the drive motor 326 is shown in a substantially outboard mounting configuration. In particular, the drive motor 326 is attached at a distal end to the frame 310 so that the drive motor 326 is entirely outside of the frame 310. As another example, a chain enclosure (not shown in FIG. 9) can be interposed between the drive motor housing 374 and the frame 310, including with the motor housing 374 being supported by the frame 310 via the chain enclosure.

Turning back to FIGS. 5 and 6, the chain enclosure 384 is shown positioned between the frame 310 and the track pods 342A, 342B. In some cases, the chain enclosure 384 can thus support the track pods 342A, 342B, including by being configured to directly couple with the frame 310 on one side and to rotatably couple with each of the track pods 342A, 342B on the other.

As is best seen in FIG. 6, each of the track pods 342A, 342B may be independently and rotatably coupled with the chain enclosure so that the drive sprocket 388 and at least a part of the drive shaft 386 may be disposed within the interior cavity 394 of the chain enclosure 384. In some cases, to achieve such a rotatable relationship, the chain enclosure 384 may include a rotatable coupling, for example a hole, bearing, bushing, or any other similar coupling as known in the art, which receives the relevant drive shaft 386 so that the respective track pod 342A, 342B can rotate independently from the other track pods, relative to the chain enclosure 384 and the frame 310. Further, with the illustrated arrangement, each track pod 342A, 342B can pivot freely even as the track pod 342A, 342B is being powered. As such, each of track pod 342A, 342B can pivot independently to maintain contact with the ground or other support surface while the loader 300 is being propelled, including where the ground or other support surface is uneven. Thus, the track pods 342A, 342B can provide enhanced traction and maneuverability.

With continued reference to FIG. 6, each of the track pods 342A, 342B may be limited to a particular degree of rotation relative to the frame 310. For example, the bracket 390 and the pin 392 can collectively provide a mechanical limit stop that prevents each of the track pods 342A, 342B from rotating too far relative to the frame 310. In particular, when each of the track pods 342A, 342B rotates about its drive shaft 386, the bracket 390 may be also rotated about the drive shaft 386 until one of the legs of the bracket 390 contacts the stationary pin 392 extending from the chain enclosure 384 (or the frame 310). Further, the relative size, shape, and position of each of the bracket 390 and the pin 392 can be readily adjusted during manufacturing (or otherwise) to achieve a customizable limit for rotation. For example, the track pods 342A, 342B may be permitted to rotate approximately 15 degrees in either direction. In some cases, limitations on rotation for front track pods may be varied from limitations on rotation for rear track pods, as may provide for improved handling, load management or stability. In some cases, a degree of permitted rotation in a forward direction may be different from a degree of permitted rotation in a rearward direction for a particular track pod, relative to a neutral (e.g., level) reference orientation (for example, limiting rotation to 5 degrees in either direction instead of 15 degrees).

As also noted above, in other embodiments, a chain enclosure may be differently configured or may not be included. In some cases, including when no chain enclosure is present, track pods may be directly rotatably mounted to a frame of a loader, which may similarly include various holes, bearing, or bushings to provide the requisite rotatable connection. Further, in such a case, a frame may also include one or more anti-rotation elements (e.g. a pin or U-shaped bracket) that can engage with one or more corresponding anti-rotation elements (e.g. a U-shaped bracket or a pin) on each of the track pods.

In chain-driven assemblies, power transmission from a motor to a chain and from a chain to a track pod can be accomplished using a variety of known configurations. For example, as shown in FIGS. 5 and 6, the drive chain 382 may be operatively connected with the drive motor 326 at the motor drive sprocket 378 and operatively connected with each of the track pods 342A, 342B at their respective drive sprockets 388 (see FIG. 6, only one shown). Thus, the single chain 382 forms a triangular chain path to transmit power from the drive motor 326 simultaneously to the connected track pods 342A, 342B, in accordance with a command from an operator, to propel the loader 300.

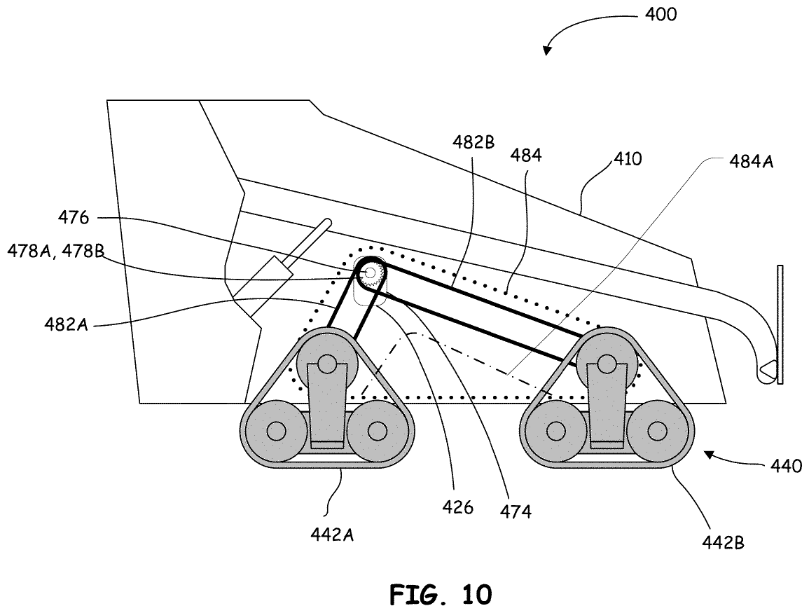

FIG. 10 illustrates another embodiment of a loader 400 in a second drive configuration, in this case with a motor mounted in a high-drive position to independently power two track pods, via separate drive chains. Generally, the loader 400 is similar to the loader 300, with each side of a frame 410 of the loader 400 (only one side shown) including a drive motor 426, a traction system 440, and a chain enclosure 484. In some cases, the drive motor 426 may be mounted with a motor housing 474 extending substantially inboard of the frame 410 and may include two motor sprockets 478A-B that may rotate together with a motor shaft 476 that extends from the motor housing 474.

The traction system 440 may include a first track pod 442A that may be supported by the frame 410 near the rear end of the frame 410, and a second endless track pod 442B that may be supported by the frame 410 near the front end of the frame 410. The traction system 440 may also include a first drive chain 482A operatively connected between the first motor sprocket 478A and a drive sprocket (not shown) of the first track pod 442A, and a second drive chain 482B operatively connected between the second motor sprocket 478b and a drive sprocket (not shown) of the second track pod 442B. Because the first and second motor sprockets 478A-B may be connected to the same motor shaft 476, each of the track pods 442A, 442B can rotate simultaneously with the drive motor 426.

The chain enclosure 484 is shown as having a triangular shape that encloses the respective chain paths of both the first drive chain 482A and the second drive chain 482B within an interior cavity 494 of the chain enclosure 484. However, other shapes of chain enclosures may also be effective at enclosing and protecting the drive chains, or other related components, including one or more motors. For example, a chain enclosure may have a V-shape to reduce material, while retaining adequate protective characteristics, including as shown by the alternate chain-enclosure profile 484A in FIG. 10. In some cases, such an arrangement can help to facilitate arrangement of retrofit kits, including via arrangement of a chain enclosure to appropriately avoid pre-existing structures or components on a power machine frame.

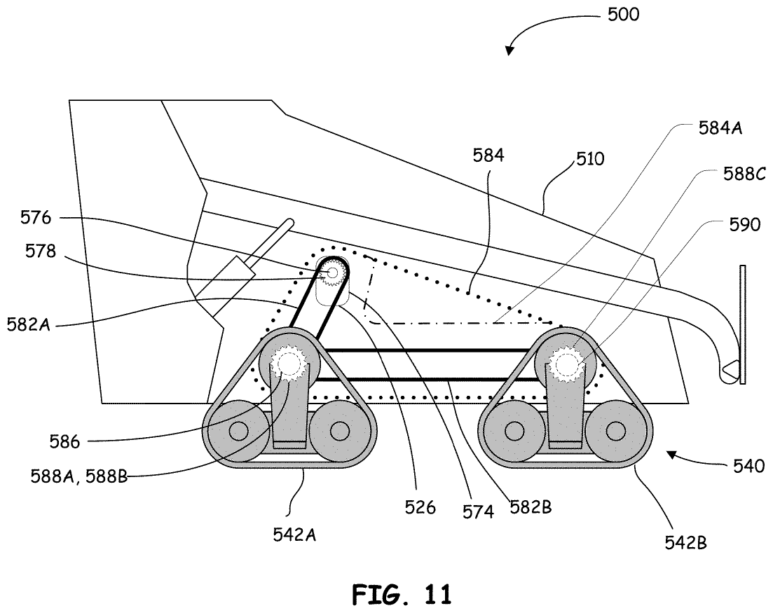

FIG. 11 illustrates another embodiment of a loader 500 in a third drive configuration, in this case with a motor mounted in a high-drive position and operatively connected with a first track pod via a first drive chain. Further, the first track pod may be operatively connected with a second track pod via a second drive chain, so that the motor powers the second track pod via the first track pod. Generally, the loader 500 is similar to the loader 300, with each side of a frame 510 of the loader 500 (only one side shown) including a drive motor 526, a traction system 540, and a chain enclosure 584. In some cases, the drive motor 526 may be mounted with a motor housing 574 substantially inboard of the frame 510 and may include a motor sprocket 578 that may be coupled to and rotate with a motor shaft 576 that extends from the motor housing 574.

The traction system 540 may include a first track pod 542A that may be supported by the frame 510 (e.g., via the chain enclosure 584) near the rear end of the frame 510, and a second endless track pod 542B that may be supported by the frame 510 (e.g., via the chain enclosure 584) near the front end of the frame 510. The first track pod 542A may include a first drive sprocket 588A and second drive sprocket 588B, each connected with a drive shaft 586 of the first track pod 542A. The second track pod 542B may include a drive sprocket 588C connected with a drive shaft 590 of the second track pod 542B. The traction system 540 may also include a first drive chain 582A and a second drive chain 582B to operatively connect the drive motor 526 and the track pods 542A, 542B.

In particular, the first drive chain 582A may operatively connect between the drive motor sprocket 578 and the first drive sprocket 588A of the first track pod 542A and the second drive chain 582B may operatively connect between the second drive sprocket 588B of the first track pod 542A and the drive sprocket 588C of the second track pod 542B. Thus, the first drive chain 582A may transfer power between the drive motor 526 and the first track pod 542A and the second drive chain 582B may transfer power between the first track pod 542A and the second track pod 542B so that the first and second track pods 542A, 542B may be powered simultaneously.

The chain enclosure 584 is shown as having a triangular shape that encloses the respective chain paths of both the first drive chain 582A and the second drive chain 582B within an interior cavity 594 of the chain enclosure 584. However, other shapes of chain enclosures may also be effective at enclosing and protecting drive chains and other relevant components, including enclosures with V-shapes, as shown by the alternate chain-enclosure profile 584A in FIG. 11.

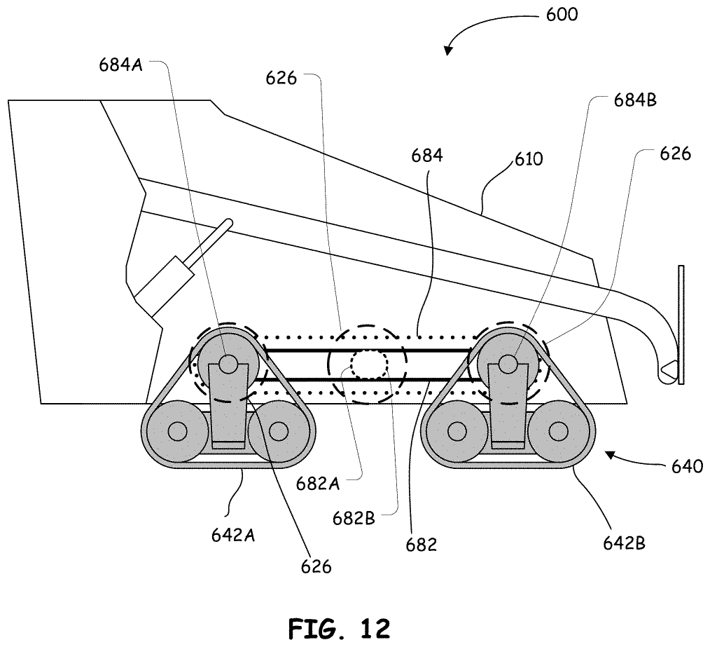

FIG. 12 illustrates another embodiment of a loader 600 in a fourth drive configuration, in which a motor may be mounted in a direct drive configuration with either of a first or a second track pod, and the first and second track pods may be operatively connected by a drive chain. Generally, the loader 600 is similar to the loader 300, with each side of a frame 610 of the loader 600 including a drive motor 626, a traction system 640, and a chain enclosure 684. In some cases, the drive motor 626 may extend substantially internally to the frame 610. In some cases, the motor 626 may extend substantially externally to the frame, including by being mounted on the exterior of the chain enclosure 684. To provide a quad-tracked configuration for the power machine 600, The traction system 640 may include a first track pod 642A that may be supported by the frame 610 (e.g., via the chain enclosure 684) near the rear end of the frame 610, and a second endless track pod 642B may supported by the frame 610 (e.g., via the chain enclosure 684) near the front end of the frame 610.

To power the track pods 642A, 642B and propel the loader forward, the motor 626 may be directly connected with either of the first or the second track pods 642A, 642B. For example, the motor shaft 676 may be directly coupled with (or may be the same as) a drive shaft 686A, 686B of either the first or the second track pods 642A, 642B. In some cases, direct coupling may include gearing or other direct power transmission elements (e.g., shafts, but not chains or belts), as is known in the art. Further, a drive chain 682 may operatively connect the first track pod 642B with the second track pod 642B so that power applied at one of the track pods 642A, 642B by the motor 626 can be transmitted by the drive chain 682 to power the other of the track pods 642B, 642A and thereby propel the loader 600. In other words, the motor 626 may directly power either the first track pod 642A or the second track pod 642B, which may in turn power the other track pod of the second track pod 642B or the first track pod 642A, respectively, so that the track pods 642A, 642B may be powered simultaneously.

The chain enclosure 684 is shown as having a generally rectangular shape having rounded ends that encloses the chain path of the drive chain 682. However, other shapes of chain enclosures may also be effective at enclosing and protecting the drive chains and any related components. In some cases, as is also generally applicable to the embodiments discussed above and below, the chain enclosure 684 can in some cases support the motor 626 relative to the frame 310, including with the motor extending substantially outboard of the chain enclosure 684, or with the motor extending substantially inboard of the frame 610 (e.g., extending through a pre-existing hold in the frame 610).

In some cases, a motor can instead by mounted to a chain enclosure vertically in line with and horizontally between two track pods. For example, in some embodiments, the motor 626 can be mounted to the chain enclosure 684 (or otherwise mounted to the frame 610) between the track pods 642A, 642B, including as shown in FIG. 12. Correspondingly, the traction system 640 may alternatively include a first drive chain 682A and a second drive chain 682B to operatively connect the drive motor 626 to the first and the second track pods 642A, 642B, respectively. Thus, the first drive chain 682A may transfer power between the drive motor 626 and the first track pod 642A and the second drive chain 582B may transfer power between the first track pod 642A and the second track pod 642B so that the first and second track pods 642A, 642B may be powered simultaneously.

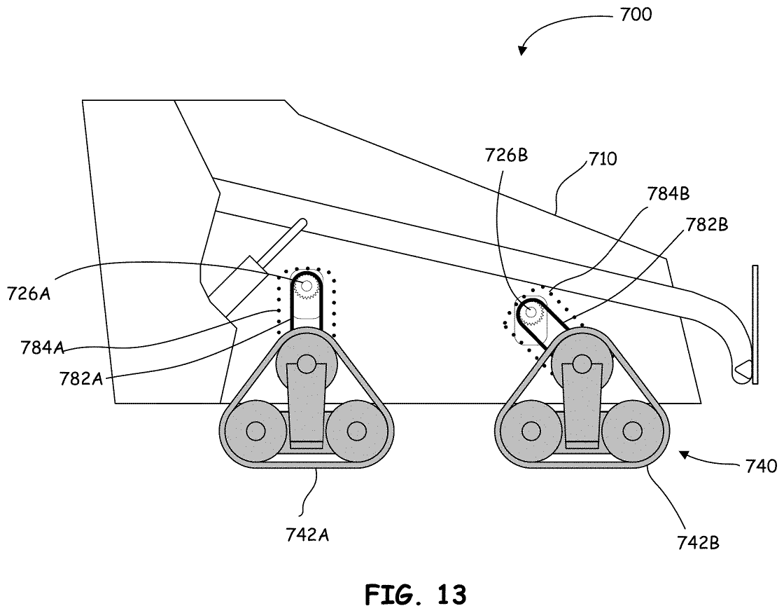

FIG. 13 illustrates another embodiment of a loader 700 in a fifth drive configuration, in which a first motor may be operatively connected with a first track pod via a first drive chain, and a second motor may be operatively connected with a second track pod by a second drive chain. Generally, the loader 700 is similar to the loader 300, with each side of a frame 710 of the loader 700 including a first drive motor 726A, a second drive motor 726B, a traction system 740, a first chain enclosure 784A, and a second chain enclosure 784B. In some cases, one or both of the drive motors 726A, 726B may be mounted to extend substantially inboard of the frame 710, with the first drive motor 726A being mounted adjacent the rear end of the loader 700 and the second motor 726B being mounted adjacent the front end of the loader 700. However, in other embodiments, either of the drive motors 726A, 726B may be mounted at other locations on the side of the loader 700, as appropriate.

The traction system 740 may include a first track pod 742A that may be supported by the frame 710 (e.g., via the chain enclosure 784A) near the rear end of the frame 710, and a second endless track pod 742B may supported by the frame 710 (e.g., via the chain enclosure 784B) near the front end of the frame 710. In particular, the first drive motor 726A is arranged above the first track pod 742A and locally below a fully lowered orientation of a lift arm of the loader 700, and the second motor 726B is arranged behind and above the second track pod 742B and locally below the fully lowered orientation of the lift arm. However, in other embodiments, other relative locations of the drive motors 726A, 726G and the track pods 742A, 742B are possible

The traction system 740 may also include a first drive chain 782A configured to operatively connect the first track pod 742A with the first drive motor 726A, and a second drive chain 782B configured to connect the second track pod 742B with the second drive motor 726B. For example, the first drive chain 782A may operatively connect between a drive sprocket of the first drive motor 726A and a drive sprocket (not shown) of the first track pod 742A, and the second drive chain 782B may operatively connect between a drive sprocket of the second drive motor 726B and a drive sprocket (not shown) of the second track pod 742B. Thus, the first drive chain 782A may transfer power between the drive motor 726A and the first track pod 742A and the second drive chain 782B may transfer power between the second drive motor 726B and the second track pod 742B. In this way, depending on the command received from an operator, the track pods 742A, 742B may be powered simultaneously or individually. Correspondingly, the power delivered and operating speed for each of the track pods 742A, 742B can be varied independently, as may improve traction and overall maneuverability.

Each of the chain enclosures 784A, 784B is shown as having a generally rectangular shape having rounded ends that encloses the chain path of each of the drive chains 782A, 782B, respectively. However, other shapes of chain enclosures may be equally effective at enclosing and protecting the drive chains and any related components, such as a motor, any gears or other direct power transmission elements, or a track pod. For example, the chain enclosures 784A, 784B may comprise portions of a single chain enclosure (not shown), which may be integrally formed or connected together with any suitable means.

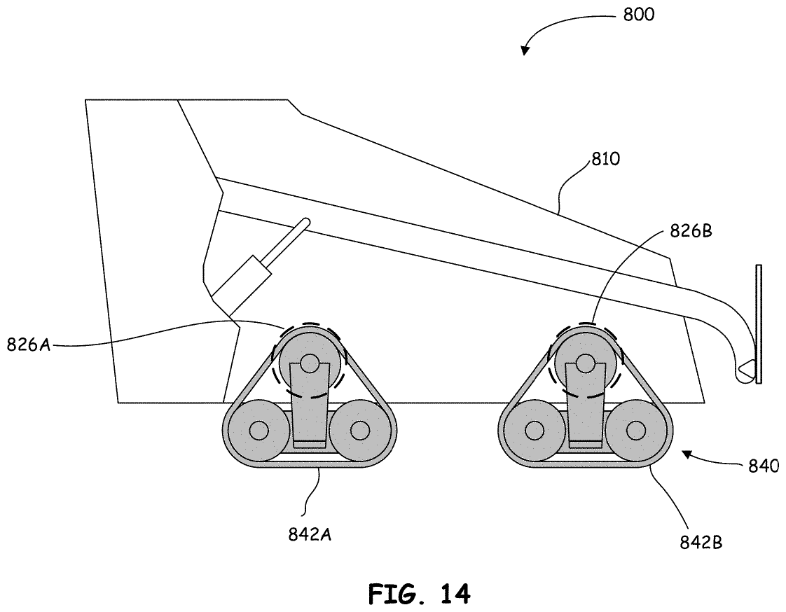

FIG. 14 illustrates another example of a loader 800 in a sixth drive configuration. In particular, the loader 800 is configured with a direct drive arrangement, in which a first motor may be directly and operatively connected with a first track pod, and a second motor may be directly and operatively connected with a second track pod. Generally, the loader 800 is similar to the loader 700, with each side of a frame 810 of the loader 800 including a first drive motor 826A, a second drive motor 826B, each of which may be mounted, in some examples, to extend substantially inboard of the side of the frame 810. The traction system 840 may include a first track pod 842A that may be directly operatively connected with the first drive motor 826A and a second track pod 842B that may be directly operatively connected with the second drive motor 826B. Thus, each track pod 842A, 842B may be powered independently via independent control of the motors 826A, 826B, as may provide increased traction and maneuverability in some cases.

Because the motors 826A, 826B may be directly connected with each of the track pods 842A, 842B, drive chains or other flexible power transmission elements may not be required. Correspondingly, chain enclosures may also not be required and the track pods 842A, 842B may instead be rotatably mounted directly to the frame 810. In some cases, this may help to provide a more compact drive system overall, including as may allow increased outboard extension of the motors 826A, 826B in some cases. However, support structures similar to the chain enclosures discussed above may still be used in some examples, including to offset the track pods 842A, 842B from the frame 410, or to protect any non-flexible power transmission elements

As also generally noted above, any of the drive configurations discussed herein, including as shown in FIGS. 5-14, may be installed on a loader during manufacturing of the loader, or may be provided as a retrofit kit for use with an existing loader equipped with a different type of drive assembly (e.g., a wheeled loader or a dual-track loader). In some retrofit examples, a retrofit assembly may include drive motors, track pods, drive chains, and chain enclosures that are assembled into a single integrated assembly, which can be readily attached to a power machine frame once a previous drive assembly has been removed. In some retrofit examples, these or other components can be provided as two or more sub-assemblies, which can be assembled together before or after (e.g., as a result of) being installed onto a power machine frame.

In some implementations, devices or systems disclosed herein can be utilized, manufactured, or installed using methods embodying aspects of the disclosure. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, for some implementations of the technology, of the utilized features and implemented capabilities of such device or system.

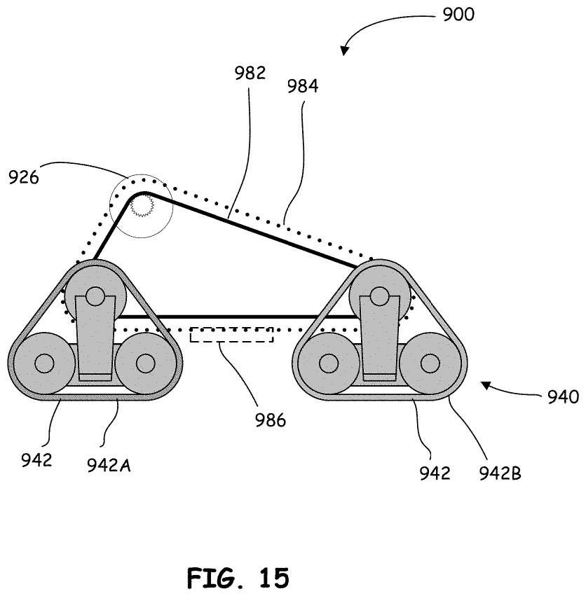

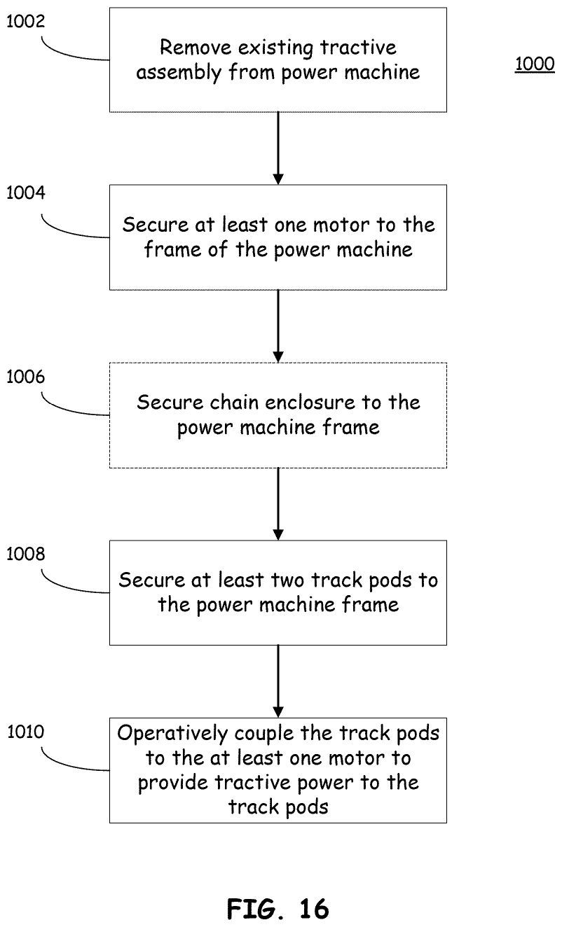

For example, referring to FIGS. 15 and 16, an illustrative example of a retrofit kit 900 and a method 1000 for installing a retrofit kit, which is applicable to the retrofit kit 900 (and other kits), are shown. The retrofit kit 900 includes a drive assembly 940 configured to attach to a side of a loader (e.g. any of the loaders 200, 300, 400, 500, 600, 700, 800). In some cases, a retrofit kit may include a second drive assembly configured to attach to a second side of a loader (e.g., a drive assembly that is manufactured to the same specifications as a drive assembly for a first side of a loader).

As shown, the drive assembly 940 may include at least one motor 926, at least two track pods 942A, 942B, at least one drive chain 982, and a chain enclosure 984. In the illustrated example, the drive assembly 940 is arranged in a configuration similar to the first, high-drive configuration shown in FIGS. 5-6. In other examples, other numbers or arrangements of motors, track pods, drive chains, or chain enclosures may be used, including so that a retrofit kit may be configured to provide any of the drive configurations illustrated in FIGS. 5-15 or otherwise presented herein.

In some examples, the retrofit kit 900 may be configured as a preassembled integral retrofit kit, with the motor 926 mounted externally (or otherwise) to the chain enclosure 984 between the track pods 942A, 942B, and the track pods 942A, 942B in turn mounted at opposite ends of the chain enclosure 984. Thus, once an existing drive assembly has been removed from the frame of a mini-loader or other power machine, the preassembled integral retrofit kit 900 may be installed as a single unit onto the frame.

In some examples, the retrofit kit 900 may include a base frame (e.g., the frame 986) that may be configured to extend underneath a loader and thereby connect the drive assembly 940 shown in FIG. 15 to another (e.g., identical) drive assembly on an opposite lateral side of the loader (not shown), once any existing drive assemblies have been removed from the loader and the retrofit kit installed. In some cases, the base frame may be configured to rigidly support the attached motors (e.g., the motor 926), track pods (e.g., the track pods 942A, 942B), drive chains (e.g., the chain 982), and any included chain enclosures (e.g., the enclosure 984). For example, the chain enclosure 984 may be secured to the base frame and each of the track pods 942A, 942B and the motor 926 may be mounted to the chain enclosure 984. Further, the base frame can in some cases be configured to support the attached drive assemblies relative to a power machine frame.

Referring in particular to FIG. 16, to install a retrofit kit (e.g., the kit 900), operations at a first block 1002 may include removing an existing drive assembly (if any) from a loader. Removal of the existing drive assembly may in some cases include removing any existing tractive elements (e.g. wheels or other endless tracks) and motors, and any other related components. In some cases, removing an existing drive assembly may not include removing an existing motor or otherwise breaking a hydraulic circuit of the relevant power machine. For example, for the various examples discussed above and below, a track assembly can sometimes be installed to operate with a pre-existing motor of a power machine.

Operations at a second block 1004 of the method 1000 may include securing at least one motor to the frame of the loader. For example, the motor 996 may be secured to extend substantially inboard of a frame of a loader. In some examples, a motor may be mounted using pre-existing holes or other mounting elements on a power machine. For example, the motor 926 may be fastened internally to the frame via fasteners that may be received by existing motor mount holes, and any required hydraulic lines or electrical connections may be connected to the motor 926. Alternatively or additionally, new mounting holes or other mounting features may be required to attach the motor 926 to the frame of the loader. In some cases, mounting of a motor under the operations block 1004 may include attaching a drive sprocket to a shaft of the motor.

In some examples, operations at a third block 1006 of the method 1000 may include securing any included a chain enclosure to the frame of the loader. For example, the chain enclosure 984 can be secured directly to the frame using any variety of known attachment techniques, including through the use of pre-existing mounting holes or weldments in some cases. In some examples, a chain enclosure can support a motor relative to a power machine frame. Accordingly, in some cases, operations at block 1006 of securing a chain enclosure to a power machine frame can form part of the operations at block 1004 of securing at least one motor to the power machine frame. In some examples, including for arrangements without chain enclosures, the operation at block 1006 may not be required.

The method 1000 can also include operations at a fourth block 1008 of securing at least two track pods (e.g., the track pods 942A, 942B) to the frame of the loader. In some cases, securing track pods to a frame of a power machine may include securing the track pods directly to the frame of the power machine. In some cases, securing track pods to a frame of a power machine can be included in the operations (at block 1006) of securing a chain enclosure (or other intervening structure) to the frame. For example, the chain enclosure 984 of FIG. 15 may be positioned between the frame and the track pods 942A, 942B in some cases, and may support the track pods 942A, 942B relative to the power machine frame. Generally, the operations, at block 1008, of securing the track pods to a frame results in each track pod being independently rotatable with respect to the frame of the loader (e.g., similar to track pods describe above). Correspondingly, operations at block 1008 may sometimes include securing anti-rotation assemblies (e.g., as described above) to limit rotation of each of the track pods.

The method 1000 can also include operations at a fifth block 1010 of operatively coupling the at least two track pods to the one or more motors to provide tractive power to the track pods. For example, operatively coupling the at least two track pods 942A, 942B to the one or more motors 926 may include connecting the one or more drive chains 982 to the at least two track pods 942A, 942B. In other cases, however, other arrangements for power transmission can be prepared under operations of block 1010, including the various arrangements presented in FIGS. 5-14.

As also generally discussed below, any one or more of the illustrated operations of the method 1000 may or may not be completed for a given implementation, and that any one or more of the illustrated operations may be completed in a different order than shown, relative to other operations. For example, the operation at block 1006 of securing the chain enclosure 984 to the frame need not be completed between the operation at block 1004 of connecting the motor 926 with the frame of the loader and the operation at block 1008 of securing the track pods 942A, 942B to the frame. In particular, in some examples, a chain enclosure may not be included and the track pods 942A, 942B may instead be connected directly to the frame of the loader. Alternatively, the operation of securing the chain enclosure 960 to the frame of the loader may precede, succeed, or be simultaneous with any of the operations of securing the motor 926 to the frame, securing the track pods 942 to the frame, or operatively coupling track pods 942A, 942B to the motor(s) 926. For example, as also noted above, the retrofit kit 900 can be fully preassembled in some cases, then installed onto a power machine as an integral unit.

As another example, in some implementations, operations at block 1002 can include removing installed tracks from a mini-loader in a dual-track configuration (i.e., with a single track on each side of the loader) and also removing the sprockets configured to drive the dual-track tracks (i.e., sprockets configured to engage directly with the dual-track tracks).

In some such cases, operations at block under the method 1000 may not include removing a motor from the power machine. For example, a motor that is installed to provide tractive power to a dual-track track via a corresponding sprocket may remain in the same location and orientation during and after the retrofit transition to a quad-track configuration. Correspondingly, for example, an operator may be able to convert a dual-track mini-loader to a quad-track mini-loader without necessarily removing or relocating any drive motors, and the method 1000, as implemented to retrofit a dual-track power machine, may sometimes not include any operations at block 1004.

Continuing with the present example, once the track sprockets are removed, replacement sprockets can be installed. For example, after a sprocket to directly drive a dual-track track has been removed from a mini-loader, a different sprocket to drive a chain to power quad-track pods can be installed in its place. Thus, for example, operations at block 1010 may sometimes include installing a chain sprocket in place of a track sprocket on either side of a mini-loader.

Correspondingly, once track pods have been secured to the mini-loader (e.g., at block 1008, as also discussed above), operations at block 1010 can further include operatively coupling the relevant motor to the relevant track pods using a chain (or multiple chains, including as discussed above). Thus, for example, an operator can implement an in-field retrofit of a dual-track power machine so that operative power can be transmitted by a chain drive to multiple track pods rather than directly to a single track by a track sprocket.

In some cases, as also discussed relative to the retrofit kit 900, a retrofit kit may include a base frame (e.g., the frame 986) that may be configured to extend underneath a loader. In some cases, such a base frame can be used to support associated drive assemblies on one or both sides of a power machine. Correspondingly, in some cases, one or more of the operations 1004, 1006, 1008 can be included in an overarching operation of securing a retrofit kit to a loader at a base frame of the kit.

Although the subject matter has been described in language specific to structural features or methodological acts, it is to be understood that the subject matter defined in the appended claims is not necessarily limited to the specific features or acts described above. Correspondingly, in some implementations, devices or systems disclosed herein can be utilized, manufactured, installed, etc. using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

What is claimed is:

1. A power machine configured as a mini-loader, the power machine comprising:
a mini-loader frame defining a front end opposite a rear end and a first side opposite a second side, the mini-loader frame being a rigid frame with an operator station at the rear end;
at least one first-side motor supported by the first side of the mini-loader frame;
at least one second-side motor supported by the second side of the mini-loader frame; and
four endless track pods including a first endless track pod rigidly supported by the first side of the mini-loader frame, a second endless track pod rigidly supported by the first side of the mini-loader frame, a third endless track pod rigidly supported by the second side of the mini-loader frame, a fourth endless track pod rigidly supported by the second side of the mini-loader frame;
wherein endless tracks of the first and second endless track pods are powered by the at least one first-side motor, and endless tracks of the third and fourth endless track pods are powered by the at least one second-side motor to propel the power machine.

2. The power machine of claim 1, wherein one or more of:
each of the four endless track pods is forward of the operator station; or
the at least one first-side motor and the at least one second-side motor are forward of the operator station.

3. The power machine of claim 1 further comprising:
at least one first drive chain that operatively connects the at least one first-side motor with the first and second endless track pods; and
at least one second drive chain that operatively connects the at least one second-side motor with the third and fourth endless track pods.

4. The power machine of claim 3, wherein the at least one first drive chain includes a first continuous drive chain that extends from the at least one first-side motor to each of the first and second endless track pods; and
wherein the at least one second drive chain includes a second continuous drive chain that extends from the at least one second-side motor to each of the third and fourth endless track pods.

5. The power machine of claim 3, wherein the at least one first drive chain includes a first continuous drive chain that extends from the at least one first-side motor to the first endless track pod and a second continuous drive chain that one of: extends from the first at least one motor to the second endless track pod, or extends from the first endless track pod to the second endless track pod; and
wherein the at least one second drive chain includes a third continuous drive chain that extends from the second at least one motor to the third endless track pod and a fourth continuous drive chain that one of: extends from the at least one second-side motor to the fourth endless track pod, or extends from the third endless track pod to the fourth endless track pod.

6. The power machine of claim 3, wherein the first and third endless track pods are supported adjacent to the front end of the mini-loader frame, and the second and fourth endless track pods are supported adjacent to the rear end of the mini-loader frame;
wherein the at least one first-side motor is secured to the first side of the mini-loader frame and is disposed above and between the first endless track pod and the second endless track pod; and
wherein the at least one second-side motor is secured to the second side of the mini-loader frame and is disposed above and between the third endless track pod and the fourth endless track pod.

7. The power machine of claim 6, wherein the at least one first drive chain operatively connects the at least one first-side motor to the first and second endless track pods with a first triangular chain path, and
wherein the at least one second drive chain operatively connects the at least one second-side motor to the third and fourth endless track pods with a second triangular chain path.

8. The power machine of claim 6, wherein each the at least one first-side motor and the at least one second-side motor substantially extends to the inside of the first and second sides of the mini-loader frame, respectively.

9. The power machine of claim 1, wherein one or more of the at least one first-side motor is configured to power at least one of the first or second endless track pods directly; and
wherein one or more of the at least one second-side motor is configured to power at least one of the third or fourth endless track pods directly.

10. The power machine of claim 9, wherein a first drive motor of the at least one first-side motor is configured to directly power the first endless track pod, a second drive motor of the at least one first-side motor is configured to directly power with the second endless track pod, a third drive motor of the at least one second-side motor is configured to directly power the third endless track pod, and a fourth drive motor of the at least one second-side motor is configured to directly power the fourth endless track pod.

11. The power machine of claim 1, wherein the at least one first-side motor and the at least one second-side motor substantially extend inboard of the first and second sides of the mini-loader frame, respectively.

12. The power machine of claim 1, wherein the at least one first-side motor and the at least one second-side motor substantially extend outboard of the first and second sides of the mini-loader frame, respectively.

13. A drive assembly for a power machine having a frame defining a first side, and a front end opposite a rear end, the drive assembly comprising:
a drive motor configured to be supported by the frame;
a first endless track pod configured to be positioned adjacent the rear end of the frame;
a second endless track pod configured to be positioned adjacent the front end of the frame;
a drive chain configured to operatively connect with at least one of the first and the second endless track pods; and
a chain enclosure configured to enclose the drive chain,
wherein the drive motor is configured to be secured to the first side of the frame of the power machine, to be positioned above and between drive axles of the first endless track pod and the second endless track pod.

14. The drive assembly of claim 13 wherein the drive chain is configured to operatively connect the drive motor to the first and second endless track pods, forming a triangular chain path.

15. The drive assembly of claim 13, wherein the drive chain is a first drive chain and is configured to operatively connect the drive motor to one of the first or second endless track pods; and
wherein a second drive chain is configured to one of:
operatively connect the one of the first or second endless track pods to the other of the first or second endless track pods; or
operatively connect the drive motor to the other of the first or second endless track pods.

16. The drive assembly of claim 13, wherein the drive motor is configured to substantially extend inboard of the frame when secured to the first side of the frame.

17. The drive assembly of claim 15, further comprising:
a chain enclosure configured to couple with the frame of the power machine, and to couple with the first and second endless track pods, to support the first and second endless track pods relative to the frame, with the chain enclosure disposed between first side of the frame and the first and second endless track pods.

18. A drive assembly retrofit kit for a power machine configured as a mini-loader having a mini-loader frame that supports a power source and a work element and that defines a front end opposite a rear end, and a first side opposite a second side, the drive assembly retrofit kit comprising:
at least one motor;
a first endless track pod configured to be mounted to the mini-loader frame with the first endless track pod adjacent the front end of the mini-loader frame on the first side of the mini-loader frame;
a second endless track pod configured to be mounted to the mini-loader frame with the second endless track pod adjacent the rear end of the mini-loader frame on the first side of the mini-loader frame; and
a drive chain assembly operatively connecting the at least one motor with the first endless track pod and the second endless track pod to provide tractive power at the first and second endless track pods.

19. The drive assembly retrofit kit of claim 18, further comprising:
at least one chain enclosure configured to enclose one or more drive chains of the drive chain assembly and to secure the first and second endless track pods to the mini-loader frame;
wherein the at least one motor is configured to be mounted to directly to the mini-loader frame, separately from the at least one chain enclosure.

20. The drive assembly retrofit kit of claim 18, wherein the at least one motor is configured to be extend inboard of the mini-loader frame, through a hole in the mini-loader frame, when the at least one motor is operatively mounted to the mini-loader frame.

21. The drive assembly retrofit kit of claim 18, further comprising:
at least one chain enclosure configured to enclose one or more drive chains of the drive chain assembly and to secure the first and second endless track pods to the mini-loader frame;
wherein the at least one motor is configured to be mounted to the mini-loader frame by the at least one chain enclosure.

22. The drive assembly retrofit kit of claim 18, further comprising:
a third endless track pod configured to be mounted to the mini-loader frame with the third endless track pod adjacent the front end of the mini-loader frame on the second side of the mini-loader frame;
a fourth endless track pod configured to be mounted to the mini-loader frame with the fourth endless track pod adjacent the front end of the mini-loader frame on the second side of the mini-loader frame; and
a base frame that supports each of the first, second, third, and fourth endless track pods and is configured to be mounted below the mini-loader frame to operatively couple the first, second, third, and fourth endless track pods to the mini-loader frame.

23. A method of converting a power machine from a wheeled or dual-track configuration to a quad-track configuration, the power machine being configured as a mini-loader with a mini-loader frame, the method comprising:
removing an existing drive assembly from the mini-loader frame;
securing at least one motor to the mini-loader frame;
securing a first endless track pod and a second endless track pod to a first side of the mini-loader frame; and
operatively coupling the at least one motor to the first and second endless track pods to provide tractive power to the first and second endless track pods.

24. The method of claim 23, further comprising:
securing a chain enclosure to the first side of the mini-loader frame, the chain enclosure being configured to support the first and second endless track pods relative to the mini-loader frame.

25. The method of claim 24, wherein the at least one motor is secured to the mini-loader frame by the chain enclosure.

26. The method of claim 24, wherein the at least one motor is secured to the mini-loader frame separately from the chain enclosure.

27. A method of converting a power machine from a dual-track configuration to a quad-track configuration, the power machine being configured as a mini-loader with a mini-loader frame, the method comprising:
removing from a first side of the power machine an installed dual-track track and dual-track track frame;
removing from the first side of the power machine an installed dual-track drive sprocket of the dual-track configuration, the dual-track drive sprocket being configured to drive the installed dual-track track with the power machine in the dual-track configuration;
securing a chain sprocket to the power machine in place of the dual-track drive sprocket;
rigidly securing a first endless track pod and a second endless track pod to the first side of the mini-loader frame; and
operatively coupling the chain sprocket to the first and second endless track pods, with one or more chains, to provide tractive power to the first and second endless track pods.

28. The method of claim 27, wherein a first-side drive motor of the power machine is secured to the power machine in a first orientation to provide tractive power to the dual-track track; and
wherein the first-side drive motor remains in the first orientation to provide tractive power to the first and second endless track pods via the chain sprocket and the chain.
